(19) United States
(12) Patent Application Publication
(10) Pub. No.: US 2013/0022331 A1
(43) Pub. Date: Jan. 24, 2013

(54) Television Having Program Recording and Playback Functions and Operating Method Thereof

(71) Applicants: Zhang-Hang Wu, Fuqing City (CN); Ping Chen, Fuqing City (CN)

(72) Inventors: Zhang-Hang Wu, Fuqing City (CN); Ping Chen, Fuqing City (CN)

(21) Appl. No.: 13/186,521

(22) Filed: Jul. 20, 2011

(51) Int. Cl. H04N 5/775

(52) U.S. Cl. 386/230; 386/E05.003

(57) ABSTRACT

A television having program recording and playback functions includes a screen, a storage unit, a sensor and a processor. The television determines whether the person is absent in front of the screen during displaying the television program and, if so, records the television program and corresponding channel information, and then determines whether a person is present in front of the screen again after the person is absent in front of the screen and, if so, controls the screen to display a menu. The television reads the recorded channel information to tune to a corresponding channel when a first option of the menu is selected, and reads the recorded television program to display the recorded television program by the screen when a second option of the menu is selected.

### BACKGROUND OF THE INVENTION

1. Field of the Invention

The present invention relates to a television and, more particularly, to a television having program recording and playback functions and an operating method thereof.

2. Description of the Related Art

As digital technology advances, a digital television provides not only better quality videos but also more expansion functions than those provided in a conventional analog television. For example, the digital television may provide functions such as web browsing and game entertainment by plugging a network interface card. The digital television may also be developed to serve as a home media center or a control center of intelligent home appliances by electrically connecting various external devices via various connector interfaces disposed on the digital television so as to extremely expand applications of the television.

Nowadays, the rhythm of life is getting faster and faster so that a person who is watching television may often have to temporarily leave to handle various things and stop watching his/her favorite television program accordingly. The most commonly used approach for solving the problem is to use a built-in or external video recorder to record missed television programs. However, sometimes there is not enough time for his/her to manipulate the video recorder to record the displayed television program before his/her leaves due to urgent matters.

Therefore, there is a need for a television having program recording and playback functions which may automatically record a displayed television program when the person leaves the television and then provide the recorded television program for the person to watch when the person returns to the television.

### SUMMARY OF THE INVENTION

The present invention is directed to providing a television having program recording and playback functions and an operating method thereof for automatically record a displayed television program when the person leaves the television and then provide the recorded television program for the person to watch when the person returns to the television.

According to one aspect of the present invention, there is provided a television having program recording and playback functions. The television includes a screen, a storage unit, a sensor and a processor. The screen is used to display a television program. The sensor is used to detect whether a person is present in front of the screen to correspondingly output a detection signal. The processor is used to receive the detection signal to determine whether the person is absent in front of the screen during displaying the television program and, if so, record and store the television program and corresponding channel information in the storage unit, and then receive the detection signal to determine whether a person is present in front of the screen again after the person is absent in front of the screen and, if so, control the screen to display a menu. When a first option of the menu is selected, the processor reads the recorded channel information stored in the storage unit to tune to a corresponding channel. When a second option of the menu is selected, the processor reads the recorded television program stored in the storage unit to display the recorded television program by the screen.

In the television of the present invention, the storage unit may include a universal serial bus (USB) flash disk. The sensor may include an infrared (IR) sensor for detecting IR radiation from a human body to determine whether a person is present in front of the screen. The sensor may be disposed on a center of a top of the screen. The processor may control the screen to display the menu by using on-screen display (OSD).

In the television of the present invention, the processor receives the detection signal to determine whether the person is absent in front of the screen during displaying the television program and, if so, may further turn off a backlight power source and/or an audio circuit of the television. Turning off the backlight power makes the television enter a power saving mode, and turning off the audio circuit makes the television become mute.

In the television of the present invention, when the first option of the menu is selected, the processor may further stop recording and storing the television program in the storage unit. When the second option of the menu is selected, the processor may further delete the recorded television program stored in the storage unit after the recorded television program is displayed completely.

According to another aspect of the present invention, there is provided an operating method of a television having program recording and playback functions. The operating method includes: displaying a television program by a screen of the television; detecting whether a person is present in front of the screen to correspondingly output a detection signal; receiving the detection signal to determine whether the person is absent in front of the screen during displaying the television program and, if so, recording and storing the television program and corresponding channel information, and then receiving the detection signal to determine whether a person is present in front of the screen again after the person is absent in front of the screen and, if so, controlling the screen to display a menu; when a first option of the menu is selected, reading the recorded channel information to tune to a corresponding channel; when a second option of the menu is selected, reading the recorded television program to display the recorded television program by the screen.

Therefore, the present invention can automatically record the displayed television program when the person leaves the television (e.g. the person is absent in front of the screen during displaying the television program) and then provide the recorded television program for the person to watch when the person returns to the television (e.g. the person is present in front of the screen again after the person is absent in front of the screen) so that the person will be no more concerned with whether it needs to manipulate the video recorder to record the displayed television program. Moreover, the present invention can automatically turn off the backlight power source and/or the audio circuit of the television when the person leaves the television so as to save power.

### BRIEF DESCRIPTION OF THE DRAWINGS

The foregoing and other features of the disclosure will be apparent and easily understood from a further reading of the specification, claims and by reference to the accompanying drawings in which:

FIG. 1 is a functional block diagram of a television having program recording and playback functions according to an embodiment of the present invention; and

FIG. 2 is a flowchart of an operating method of a television having program recording and playback functions according to an embodiment of the present invention.

### DETAILED DESCRIPTION OF THE INVENTION

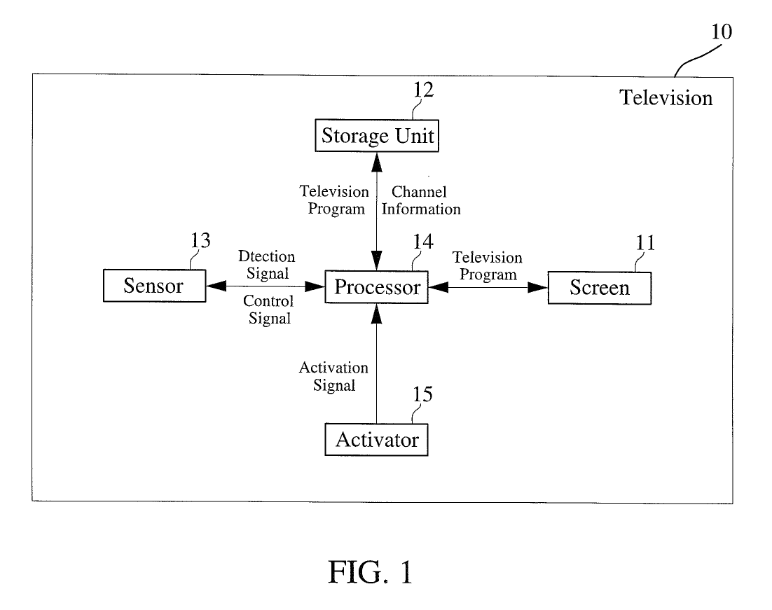

FIG. 1 is a functional block diagram of a television having program recording and playback functions according to an embodiment of the present invention. Referring to FIG. 1, a television 10 includes a screen 11, a storage unit 12, a sensor 13, a processor 14 and an activator 15. In the embodiment, the screen 11, the storage unit 12, the sensor 13 and the activator 15 are electrically connected to the processor 14. The television 10 may be a liquid-crystal display (LCD) television, a plasma display panel (PDP) television, an organic light-emitting diode (OLED) television, a cathode-ray tube (CRT) television or a projection television.

The screen 11 is used to display a television program. The television program may be a live television program broadcasted on the channel to which the television 10 is currently tuned. The television program may also be a recorded television program stored in the storage unit 12.

The storage unit 12 is used to store one or more recorded television programs and corresponding channel information. The channel information corresponding to the recorded television program may include a channel number and a channel name corresponding to the recorded television program. The storage unit 12 may include a built-in storage unit such as a fixed hard disk or a memory in the television 10. The storage unit 12 may also include an external storage unit such as an external hard disk, a portable flash disk or a memory card, in which the portable flash disk may include a universal serial bus (USB) flash disk.

The sensor 13, when being activated, is used to detect whether a person is present in front of the screen 11 to correspondingly output a detection signal. When a person is present in front of the screen 11, the sensor 13 outputs the detection signal indicating a person present in front of the screen 11. When no person is present in front of the screen 11, the sensor 13 outputs the detection signal indicating no person present in front of the screen 11. The sensor 13 may include an infrared (IR) sensor for detecting IR radiation from a human body to determine whether a person is present in front of the screen 11 to correspondingly output the detection signal. The sensor 13 may be disposed on a center of a top of the screen 11, for example, the center of the top of a frame (not shown) included and surrounding the screen 11.

The processor 14 is used to receive the detection signal to determine whether the person is absent in front of the screen 11 during displaying the television program. If the person is absent in front of the screen 11 during displaying the television program, the processor 14 records and stores the television program and corresponding channel information in the storage unit 12 through a firmware having audio/video recording function; in one embodiment, the processor 14 may further turn off a backlight power source (not shown) and/or an audio circuit (not shown) of the television 10, in which turning off the backlight power makes the television 10 enter a power saving mode such as a standby or sleep mode, and turning off the audio circuit makes the television 10 become mute so as to save power. Then, the processor 14 receives the detection signal to determine whether a person is present in front of the screen 11 again after the person is absent in front of the screen 11.

If a person is present in front of the screen 11 again after the person is absent in front of the screen 11, the processor 14 controls the screen 11 to display a menu, for example, by using on-screen display (OSD); and, of course, the processor 14 will turn on the backlight power source and the audio circuit if they were turned off previously. The menu includes a plurality of user selectable options such as a first option and a second option. When the first option is selected, the processor 14 reads the recorded channel information stored in the storage unit 12 to tune to a corresponding channel; in one embodiment, the processor 14 may further stop recording and storing the television program in the storage unit 12. When the second option is selected, the processor 14 reads the recorded television program stored in the storage unit 12 to display the recorded television program by the screen 11; in one embodiment, the processor 14 may further delete the recorded television program stored in the storage unit 12 after the recorded television program is displayed completely. The processor 14 may be a micro processor unit (MPU) or a micro control unit (MCU).

The activator 15 is used to provide an activation signal sent to the processor 14 to notify the processor 14 so that the processor 14 outputs a control signal to activate the sensor 13. The activator 15 may be one or more keys disposed on a proper position of the television 10, for example, a side or bottom of the frame (not shown) included and surrounding the screen 11. The activator 15 may also be one or more keys disposed on a remote controller (not shown) adapted for the television 10.

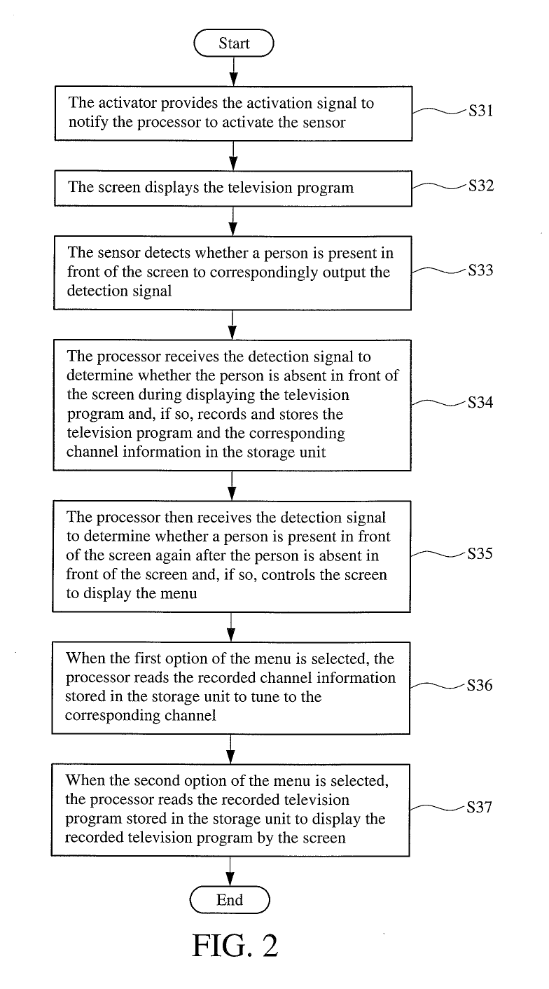

FIG. 2 is a flowchart of an operating method of a television having program recording and playback functions according to an embodiment of the present invention. Taking the television 10 shown in FIG. 1 as an example, referring to FIGS. 1 and 2, the operating method includes the following steps.

At the step S31, the activator 15 provides the activation signal sent to the processor 14 to notify the processor 14 so that the processor 14 outputs the control signal to activate the sensor 13.

At the step S32, the screen 11 displays the television program; in other words, the television program is displayed on television 10.

At the step S33, the activated sensor 13 detects whether a person is present in front of the screen 11 to correspondingly output the detection signal.

At the step S34, the processor 14 receives the detection signal to determine whether the person is absent in front of the screen 11 during displaying the television program and, if so, records and stores the television program and the corresponding channel information in the storage unit 12 so that the television 10 may automatically record the displayed television program when the person leaves the television 10 (e.g. the person is absent in front of the screen 11 during displaying the television program) and then provide the recorded television program for the person to watch when the person returns to the television 10 (e.g. the person is present in front of the screen 11 again after the person is absent in front of the screen 11). Moreover, the processor 14 further turns off the backlight power source to make the television 10 enter the power saving mode, and turns off the audio circuit to make the television 10 become mute so as to save power.

At the step S35, the processor 14 then receives the detection signal to determine whether a person is present in front of the screen 11 again after the person is absent in front of the screen 11 and, if so, controls the screen 11 to display the menu by using on-screen display (OSD). The menu includes a first option and a second option.

At the step S36, when the first option of the menu is selected, the processor 14 reads the recorded channel information stored in the storage unit 12 to tune to a corresponding channel so that the person may continue watching the television program broadcasted on the channel to which the television 10 was previously tuned. Moreover, the processor 14 further stops recording and storing the television program in the storage unit 12.

At the step S37, when the second option of the menu is selected, the processor 14 reads the recorded television program stored in the storage unit 12 to display the recorded television program by the screen 11 for the person to watch. Moreover, the processor 14 further deletes the recorded television program stored in the storage unit 12 after the recorded television program is displayed completely.

In summary, the present invention can automatically record the displayed television program when the person leaves the television (e.g. the person is absent in front of the screen during displaying the television program) and then provide the recorded television program for the person to watch when the person returns to the television (e.g. the person is present in front of the screen again after the person is absent in front of the screen) so that the person will be no more concerned with whether it needs to manipulate the video recorder to record the displayed television program displayed on television. Moreover, the present invention can automatically turn off the backlight power source and/or the audio circuit of the television when the person leaves the television so as to save power.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

I claim:

1. A television having program recording and playback functions, comprising:
a screen for displaying a television program;
a storage unit;
a sensor for detecting whether a person is present in front of the screen to correspondingly output a detection signal; and
a processor for receiving the detection signal to determine whether the person is absent in front of the screen during displaying the television program and, if so, recording and storing the television program and corresponding channel information in the storage unit, and then receiving the detection signal to determine whether a person is present in front of the screen again after the person is absent in front of the screen and, if so, controlling the screen to display a menu, wherein when a first option of the menu is selected, the processor reads the recorded channel information stored in the storage unit to tune to a corresponding channel, and when a second option of the menu is selected, the processor reads the recorded television program stored in the storage unit to display the recorded television program by the screen.

2. The television of claim 1, wherein the storage unit comprises a universal serial bus (USB) flash disk.

3. The television of claim 1, wherein the sensor comprises an infrared (IR) sensor for detecting IR radiation from a human body to determine whether a person is present in front of the screen.

4. The television of claim 1, wherein the sensor is disposed on a center of a top of the screen.

5. The television of claim 1, wherein the processor controls the screen to display the menu by using on-screen display (OSD).

6. The television of claim 1, wherein the processor receives the detection signal to determine whether the person is absent in front of the screen during displaying the television program and, if so, further turns off a backlight power source of the television to make the television enter a power saving mode.

7. The television of claim 1, wherein the processor receives the detection signal to determine whether the person is absent in front of the screen during displaying the television program and, if so, further turns off an audio circuit of the television to make the television become mute.

8. The television of claim 1, wherein when the first option of the menu is selected, the processor further stops recording and storing the television program in the storage unit.

9. The television of claim 1, wherein when the second option of the menu is selected, the processor further deletes the recorded television program stored in the storage unit after the recorded television program is displayed completely.

10. An operating method of a television having program recording and playback functions, comprising:
displaying a television program by a screen of the television;
detecting whether a person is present in front of the screen to correspondingly output a detection signal;
receiving the detection signal to determine whether the person is absent in front of the screen during displaying the television program and, if so, recording the television program and corresponding channel information, and then receiving the detection signal to determine whether a person is present in front of the screen again after the person is absent in front of the screen and, if so, controlling the screen to display a menu;
when a first option of the menu is selected, reading the recorded channel information to tune to a corresponding channel;
when a second option of the menu is selected, reading the recorded television program to display the recorded television program by the screen.
